(19) United States
(12) Patent Application Publication
(10) Pub. No.: US 2013/0265909 A1
(43) Pub. Date: Oct. 10, 2013

(54) METHOD OF EXTENDING ROUTING PROTOCOL FOR M2M SERVICES IN WIRELESS MESH NETWORK

(71) Applicants: Jung Soo PARK, Daejeon (KR); Hyoung Jun Kim, Daejeon (KR)

(72) Inventors: Jung Soo PARK, Daejeon (KR); Hyoung Jun Kim, Daejeon (KR)

(73) Assignee: Electronics and Telecommunications Research Institute, Daejeon (KR)

(21) Appl. No.: 13/597,809

(22) Filed: Aug. 29, 2012

(30) Foreign Application Priority Data
Apr. 5, 2012 (KR) 10-2012-0035437

(51) Int. Cl. H04W 84/18

(52) U.S. Cl. 370/255

(57) ABSTRACT

A method of extending a routing protocol for supporting an M2M service in a wireless mesh basic service set (MBSS) is provided. A method of extending a routing protocol that sets a mesh station (M-STA) that is connected to a distribution system in M-STAB of an MBSS to a mesh gate, in which the mesh gate transmits a RANN message and a gate announcement message to the M-STA, in which the mesh gate receives a path request message from the M-STA, and in which the mesh gate stores a path from the mesh gate to the M-STA based on the received path request message is provided. Because an M2M service terminal can be connected to the M-STA, the M-STA receives data from an M2M service terminal and the received data is included in a proxy update message, and the proxy update message is transmitted to the mesh gate.

### CROSS-REFERENCE TO RELATED APPLICATION

This application claims priority to and the benefit of Korean Patent Application No. 10-2012-0035437 filed in the Korean Intellectual Property Office on Apr. 5, 2012, the entire contents of which are incorporated herein by reference.

### BACKGROUND OF THE INVENTION

(a) Field of the Invention

The present invention relates to a wireless mesh network. More particularly, the present invention relates to a method of extending a routing protocol for supporting a machine to machine (M2M) communication service in a wireless mesh network environment.

(b) Description of the Related Art

Currently, research for converting and developing wireless ad-hoc networking technology for a popular and commercial purpose such as providing a wireless Internet service as well as a military purpose or a special purpose has been actively performed. In such a process, a naturally rising technology is wireless mesh networking.

Wireless mesh networking is technology that loads a networking function such as multi-hop routing at an access point (AP) that is used in an existing wireless local area network (WLAN) and that covers a wide region without connection to a wire network by connecting APs using wireless communication technology. A WLAN service generally has a merit that it can perform high speed data communication of 2 Mbps or more, but because a network connection can be performed only in a specific area in which an AP is installed, network extension is not easy, and in order to cover a wide area such as an outdoor region, many APs should be installed. However, when using wireless mesh networking technology, it is unnecessary to connect all APs to a wire communication network and thus a wireless Internet service can be provided in a wider region with a less expensive installation cost.

An IEEE 802.11s routing protocol is a standard that defines various techniques for the wireless mesh network. Mesh networking is added to existing IEEE 802.11, and an IEEE 802.11s routing protocol is defined so that wireless devices perform mutual communication in an ad hoc network. The IEEE 802.11s routing protocol supports broadcast/multicast and unicast between APs. The IEEE 802.11s routing protocol provides a routing protocol such as an ad hoc on-demand distance vector (AODV) and a hybrid wireless mesh protocol (HWMP), which is proactive method tree-type hybrid path selection technique, and allows use of a routing protocol such as radio-aware optimized link state routing (RA OLSR) that is provided by other venders.

The IEEE 802.11s standard is an appropriate method when forming a new network at a street light, a traffic light, and a bus stop in a city, but in order to support a moving apparatus such as vehicles or a sensor that can be frequently detached, it is necessary to quickly reflect a change situation through extension of a protocol.

### SUMMARY OF THE INVENTION

The present invention has been made in an effort to provide a method of extending a routing protocol in order to provide an M2M machine in a wireless mesh network environment.

An exemplary embodiment of the present invention provides a method of routing in a wireless mesh network (MBSS). The method includes: transmitting a gate announcement message to a plurality of mesh stations (M-STAB) of the MBSS; receiving a first path request message from a first M-STA of the plurality of M-STAB by the mesh gate; transmitting a first path reply message to the first M-STA in response to the first path request message; and storing path information from the mesh gate to the first M-STA based on the first path request message.

Another embodiment of the present invention provides a method of extending a routing protocol at a mesh AP that performs a function of an AP of a plurality of M-STAB of an MBSS. The method includes receiving information of a general station from the general station that is positioned at a lower level of the mesh AP, transmitting a proxy update message including information of the general station to a mesh gate of the MBSS, and receiving a proxy update determination message from the mesh gate in response to the proxy update message.

Another embodiment of the present invention provides a method of extending a routing protocol at a mesh AP that performs a function of an sensor gateway of a plurality of M-STAs of an MBSS. The method includes receiving information of a sensor from the sensor that is positioned at a lower level of the mesh AP, transmitting a proxy update (PXU) message comprising information of the sensor to a mesh gate of the MBSS, and receiving a proxy update confirmation (PXUC) determination message from the mesh gate in response to the PXU message.

### BRIEF DESCRIPTION OF THE DRAWINGS

FIG. 1 is a diagram illustrating a wireless mesh network and another network that is connected thereto according to an exemplary embodiment of the present invention.

FIG. 2 is a diagram illustrating an initial path selection procedure between a mesh gate and a mesh station according to an exemplary embodiment of the present invention.

FIG. 3 is a diagram illustrating a procedure in which a mesh gate restarts path selection according to an exemplary embodiment of the present invention.

FIG. 4 is a diagram illustrating a maintenance management procedure of a preset mesh network path and an update procedure of path information according to an exemplary embodiment of the present invention.

FIG. 5 is a diagram illustrating a data transmission procedure of a mesh network and a general station according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, an M2M service support technique in a wireless mesh network according to an exemplary embodiment of the present invention will be described in detail with reference to the drawings.

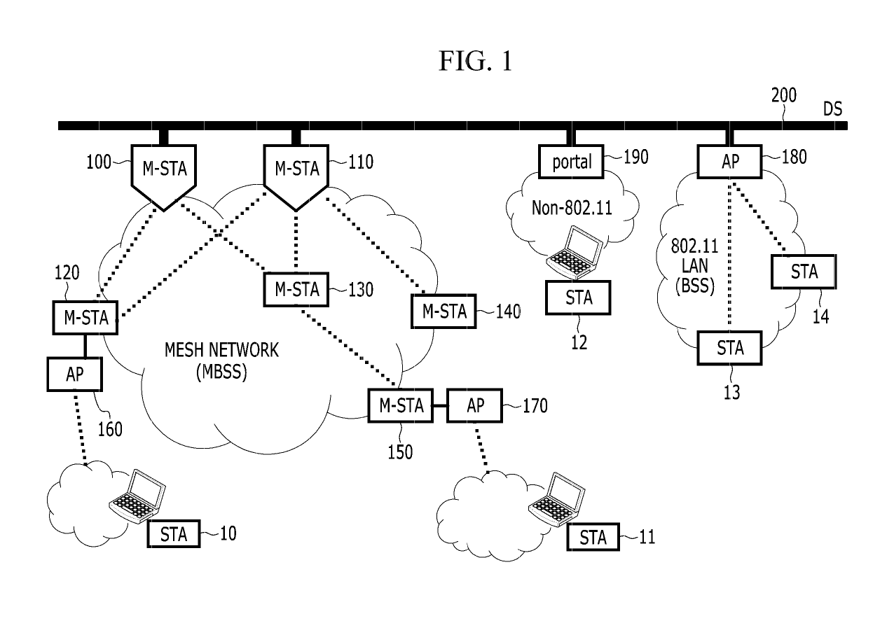

FIG. 1 is a diagram illustrating a wireless mesh network and another network that is connected thereto according to an exemplary embodiment of the present invention.

Referring to FIG. 1, a wireless mesh basic service set (MBSS) includes a plurality of mesh stations (M-STA) 100-150.

The M-STAB 100-150 are stations in which a mesh routing protocol operates, and may be stations that are defined in, for example, IEEE 802.11s specification. Each M-STA performs a relay function as well as a function as a terminal, and thus can forward data over multi-hops and can perform a path selection function.

Some of a plurality of M-STAB may be coupled to an AP or a mesh gate, or may have a function of an AP or a mesh gate. In FIG. 1, the M-STAs 100 and 110 are connected to a distribution system (DS) 200 with a function of an M-STA to perform a function of a mesh gate that can interlock with an external network (the M-STAB 100 and 110, which are shown as pentagons, and hereinafter, M-STAB 100 and 110 are referred to as “mesh gates”). Further, in FIG. 1, the M-STAB 120 and 150 are connected to APs 160 and 170 with a function of an M-STA to perform a function of a mesh AP of providing a service to a WLAN terminal.

Unlike FIG. 1, in order to form a sensor network, a sensor gateway that receives sensing information from a sensor may be connected to the M-STAB 120, 140, and 150. When an AP is connected to the M-STAB 120, 140, and 150, the mesh network transmits and receives data to and from stations 10-14 such as laptop computers and PDAs using a WLAN, and when a sensor gateway is connected, the mesh network transmits and receives data to and from an individual sensor forming a sensor network.

In FIG. 1, the M-STA 130 performs a function as a repeater of a mesh network for forwarding the received message to an upper level station or a lower level station. The M-STAB 120, 140, and 150 are end apparatuses of a mesh network and participate in path selection of a mesh gate.

As shown in FIG. 1, when each M-STA performs a function of a mesh gate, an internal flag, for example, a “MESH_GATE” flag, is set as “TRUE”, when each M-STA performs a function of a repeater, a “MESH_FORWARDING” flag is set as “TRUE”, and when each M-STA performs a function of an end apparatus, an “M2M_SRV” flag is set as “TRUE”.

In addition, a general data transmission procedure between general stations 10 and 11 follows a procedure that is defined in a mesh network standard, and the general stations 10 and 11 may be M2M service terminals. When the general stations 10 and 11 are M2M service terminals, the M2M service terminal can communicate with an external network through the DS 200 via the mesh gates 100 and 110. That is, data that the M2M service terminal provides is collected from an M-STA that is connected to the AP to be forward to an external network through each of the mesh gates 100 and 110, and information of the M2M service terminal is also collected from the M-STAB 120 and 150 that are connected to the APs 160 and 170 and is then forwarded to an M2M service server of an external network.

In FIG. 1, stations 13 and 14 constituting an IEEE 802.11 network are connected to the DS 200 through an AP 180, and a station 12 that is included in a network that is not a network of an IEEE 802.11 specification is connected to the DS 200 through a portal 190. Accordingly, stations that are included in different networks such as a mesh network, a network having no IEEE 802.11 specification, and a network of an IEEE 802.11 specification may be networked to each other through the DS 200.

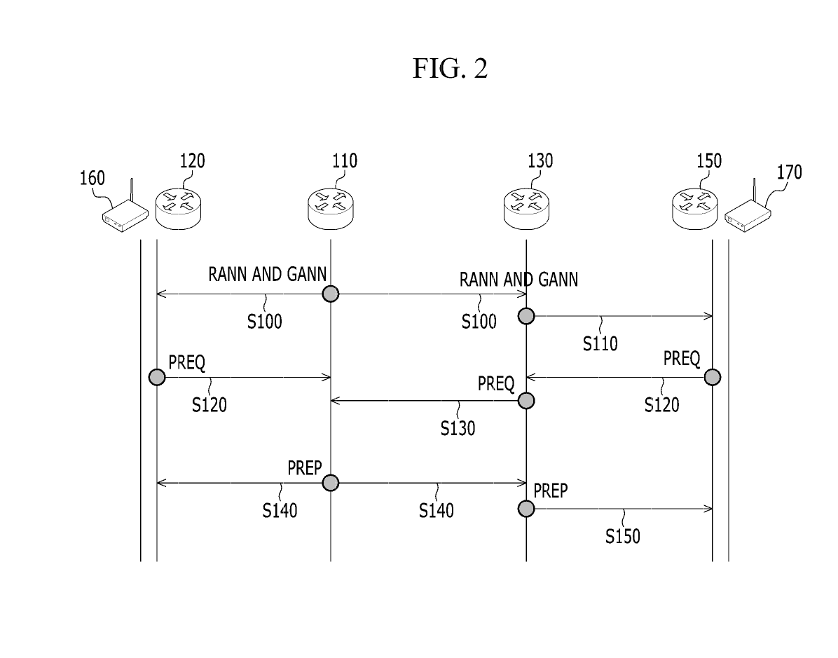

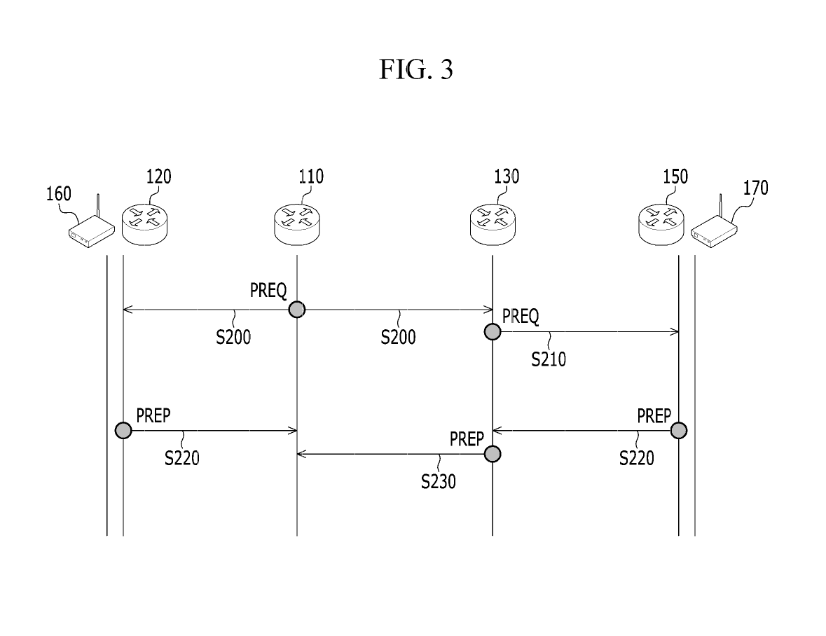

Hereinafter, a path selection procedure in a mesh network will be described with reference to FIGS. 2 and 3.

FIG. 2 is a diagram illustrating an initial path selection procedure between a mesh gate and an M-STA according to an exemplary embodiment of the present invention.

Referring to FIG. 2, the mesh gate 110 transmits a root announcement (RANN) message by broadcast and notifies that the mesh gate 110 is a root of a corresponding MBSS (S100). A mesh gate in which an internal flag representing a root in mesh gates, for example, a “MESH_ROOT” flag, is set as “TRUE,” may be a root of a mesh network

In FIG. 2, the mesh gate 110 is set as a root of a mesh network. The RANN message is periodically transmitted according to a transmission interval (RANN_INTERVAL) value that is stored at the mesh gate 110, and the RANN_INTERVAL may be included in the RANN message.

All mesh gates 100 and 110 within the mesh network transmit a gate announcement (GANN) message notifying that the mesh gates 100 and 110 perform a function of a gateway that may be connected to the external Internet (S100). Each mesh gate may store a list (M2M_SRV_LIST) of an M-STA that is connected thereto, and an address of the M-STA, for example, a media access control (MAC) address, may be stored in the M2M_SRV_LIST. In this case, when the MAC address of the M-STA exists in the M2M_SRV_LIST of the mesh gates 100 and 110, the mesh gates 100 and 110 transmit a GANN message to the M-STA by unicast. Alternatively, when a MAC address does not exist in a list of the mesh gates 100 and 110 or when the M2M_SRV_LIST is not defined to the mesh gates 100 and 110, the mesh gates 100 and 110 transmit a GANN message by broadcast, and thus all M-STAB within a mesh network may receive a GANN message.

Such a GANN message is periodically transmitted according to a transmission interval value that is stored at the mesh gates 100 and 110, and the transmission interval value may be included in the GANN message. In this case, a transmission interval (GANN_UNICAST_INTERVAL) value when transmitting by unicast may be set differently from a transmission interval (GANN_BROADCAST_INTERVAL) value when transmitting by broadcast, for example, to a small value.

When the mesh gate 110 is a root, a GANN message is transmitted together with a RANN message, and thus when transmitting a RANN message by broadcast, the GANN message may also be transmitted by broadcast regardless of an M2M_SRV_LIST of a mesh gate.

The mesh gate 100 that is not set to a root does not send a RANN message and sends only a GANN message.

An end apparatus 120 that is directly connected to the mesh gate 110 instead of being connected through a repeater 130 directly receives a RANN message and/or a GANN message from the mesh gate 110, and an end apparatus 150 that is connected to the mesh gate 110 through the repeater 130 receives a RANN message and/or a GANN message from the mesh gate 110 through the repeater 130. That is, the repeater 130 forwards the received RANN message and/or GANN message to a lower level apparatus thereof, thereby performing a function of a repeater (S110). In this case, the lower level apparatus may be the end apparatuses 120 and 150 and may be another repeater (not shown) existing in a path between the repeater 130 and the end apparatuses 120 and 150. In this case, the repeater may store information about a transmission interval value that is included in a RANN message and a GANN message.

When a RANN message and a GANN message that are directly transmitted from the mesh gates 100 and 110 or that are forwarded from the repeater 130 arrive at the end apparatuses 120 and 150, the end apparatuses 120 and 150 transmit a path request (PREQ) message using the mesh gates 100 and 110 that sends the RANN message and/or the GANN message as the destination (S120).

The ending apparatus indicates an apparatus that is included in an M2M_SRV_LIST of a mesh gate, and an M-STA may become a mesh gate.

Referring to FIG. 2, a PREQ message that is transmitted from the end apparatus 120 immediately arrives at the mesh gate 110, but the PREQ message that is transmitted from the end apparatus 150 arrives at the mesh gate 110 via the repeater 130. That is, the repeater 130 performs a function of relaying a PREQ message that it receives from the end apparatuses 120 and 150 (S130), and in this case, the repeater 130 may include a MAC address thereof in a PREQ message to relay to an upper level apparatus. In this case, the upper level apparatus may be the mesh gate 110 and may be another repeater (not shown) existing on a path that connects the repeater 130 and the mesh gate 110. Further, the repeater 130 may store information about an upper level apparatus, a lower level apparatus, a mesh gate of a path, and an end apparatus thereof on a path that connects the mesh gates 100 and 110 and the end apparatus 150.

The mesh gate 110 stores entire path information from the mesh gate 110 to the end apparatuses 120 and 150 based on information that is included in a PREQ message that it receives from each of the end apparatuses 120 and 150. In this case, information that is included in the used PREQ message may be a MAC address of each apparatus. Thereafter, the mesh gate 110 transmits a path reply (PREP) message toward the end apparatuses 120 and 150 in response to the PREQ message (S140). In this case, the mesh gate 110 may include the entire stored path information in the PREP message.

The end apparatus 120 that is directly connected to the mesh gate immediately receives a PREP message. However, the end apparatus 150 that is connected to the mesh gate 110 via the repeater 130 receives a PREP message through relay of the repeater 130 (S150). In this case, the repeater 130 may include a MAC address thereof in a PREP message to forward to a lower level apparatus. As the end apparatus 150 receives a PREP message, an initial path selection procedure is complete.

FIG. 3 is a diagram illustrating a procedure in which a mesh gate restarts path selection according to an exemplary embodiment of the present invention.

Referring to FIG. 3, when the mesh gate 110 determines that paths that are set through an initial path selection procedure do not include an entire MBSS, the mesh gate 110 again sets a path between the corresponding mesh gate 110 and the end apparatuses 120 and 150. In this case, the mesh gate 110 transmits a PREQ message by unicast based on a MAC address that is recorded at an M2M_SRV_LIST of the mesh gate 110 (S200).

The repeater 130 relays a PREQ message that is transmitted from the mesh gate 110 (S210), as in an initial path selection procedure. In this case, the repeater 130 may store a MAC address thereof at a PREQ message to forward to a lower level apparatus, and the repeater 130 may store information about an upper level apparatus, a lower level apparatus, a mesh gate of a path, and an end apparatus thereof on a path that connects the mesh gates 100 and 110 and the end apparatus 150.

Thereafter, the end apparatuses 120 and 150 having received a PREQ message transmit a PREP message toward the mesh gate 110 that transmits a PREQ message (S220). In this case, the repeater 130 relays a PREP message (S230). Further, the repeater 130 may include a MAC address thereof in a PREP message to forward to an upper level apparatus, and the repeater 130 may store information about an upper level apparatus, a lower level apparatus, a mesh gate of a path, and an end apparatus thereof.

Finally, as the mesh gate 110 having received a PREP message stores entire path information to the end apparatuses 120 and 150, a restarted path selection procedure is terminated.

A procedure that restarts path selection may be performed several times according to a state of setting path information.

When paths that are set through a step that is described with reference to FIGS. 2 and 3 include an entire MBSS, all mesh gates within an MBSS store path information of M-STAB that are included in an M2M_SRV_LIST. In this case, path information may be stored on a MAC address basis of each M-STA, and for example, may be stored in a form of M2M_PATH_LIST (MAC address of M-STA). In this case, path information of all repeaters is included in the stored path information.

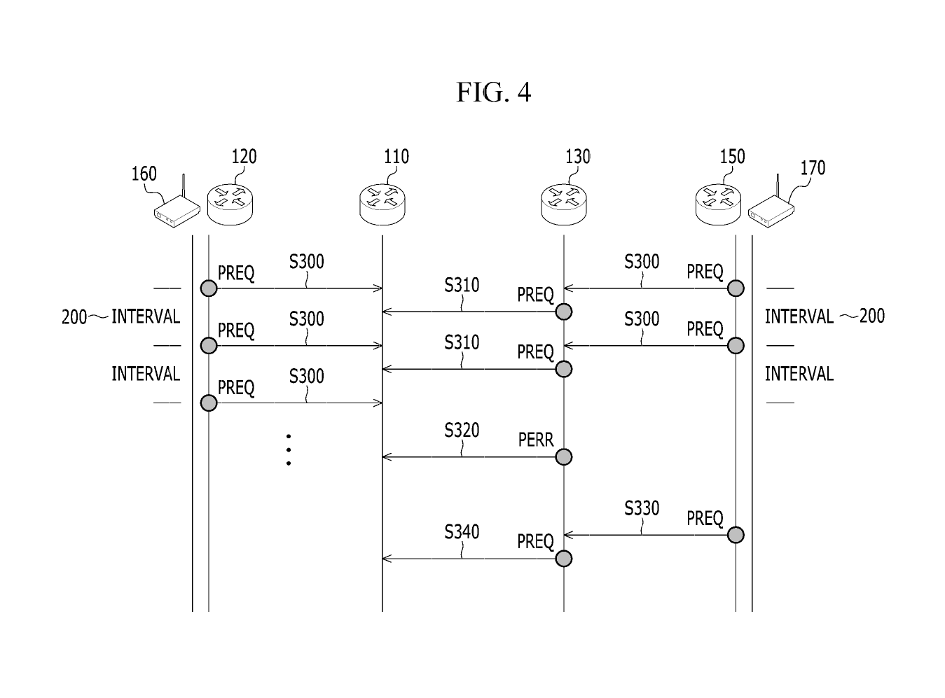

FIG. 4 is a diagram illustrating a maintenance management procedure of a preset mesh network path and an update procedure of path information.

Referring to FIG. 4, the end apparatuses 120 and 150 of the MBSS periodically transmit a PREQ message to the mesh gate 110 (S300). In this case, after a PREP message is received from the mesh gate 110, the PREQ message may be transmitted at a separately specified transmission interval (M2M_SRV_INTERVAL) 200, and the transmission interval 200 of the PREQ message may be set equally to a GANN_BROADCAST_INTERVAL or a GANN_UNICAST_INTERVAL of a GANN message, and in this case, the PREQ message is transmitted one time for a GANN_INTERVAL of the GANN message. The repeater 130 forwards a PREQ message that is transmitted from the end apparatus 150 to the upper level apparatus (S310), and in this case, the repeater 130 may include a MAC address thereof in a PREQ message to forward to an upper level apparatus. Path information of the MBSS is maintained and managed through the above-described step.

However, when the repeater 130 does not receive a PREQ message from the lower level apparatus 150 for the transmission interval 200, the repeater 130 transmits a path error (PERR) message to the upper level apparatus using the mesh gate 110 on a path as the destination (S320). Thereby, the repeater 130 may notify the mesh gate 110 that the lower level apparatus 150 is broken.

The mesh gate 110 having received a path error message from the repeater 130 updates information about a broken apparatus while maintaining a path with existing M-STAB. However, after a predetermined time, when the lower level apparatus 150 of the repeater 130 again transmits a PREQ message (S330), the repeater 130 again transmits the PREQ message to the upper level apparatus (in this case, the mesh gate 110) (S340), and when the mesh gate 110 again normally receives a PREQ message from the repeater 130, the mesh gate 110 deletes information about the updated broken apparatus.

The mesh gates 100 and 110 within an MBSS may update firstly set path information to changed path information that is changing in real time through the above step. Further, when information about apparatuses that are connected to all mesh gates is considered, path information that can be changed in real time may be searched for, and it can be thus detected that an abnormal situation occurs in a specific apparatus of the MBSS, a type of an abnormal situation of the apparatus can be searched for, and the direction that the situation is propagated in can be detected.

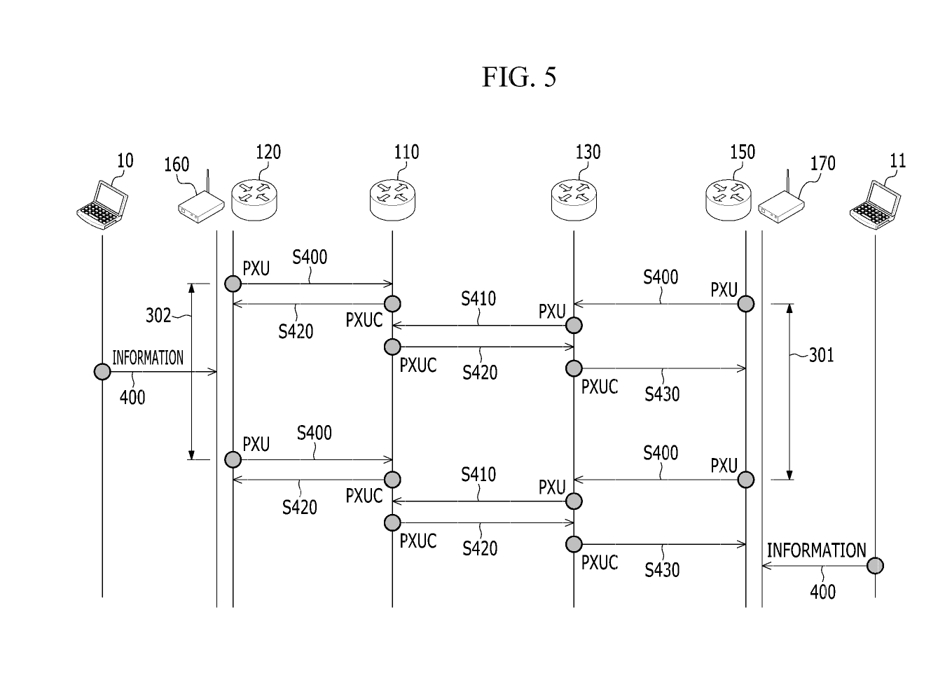

FIG. 5 is a diagram illustrating a data transmission procedure of a mesh network and a general station.

Referring to FIG. 5, because the end apparatuses 120 and 150 and the APs 160 and 170 that are connected thereto maintain a plurality of general stations 10 and 11 at a lower part thereof, the end apparatuses 120 and 150 receive data from the general stations 10 and 11 through the APs 160 and 170.

The end apparatuses 120 and 150 periodically transmit a proxy update (PXU) message to the mesh gate 110 (S400), and information 400 that is received from the general stations 10 and 11 may be included in the PXU message. Further, MAC address information of the stations 10 and 11 that are positioned at a lower part of a present AP may be included in the PXU message, and then only changed information may be forwarded. Transmission cycles 301 and 302 of the PXU message may be managed with transmission interval information (M2M_SRV_Legacy_INTERVAL), and the transmission interval information may be changed according to a network situation.

When the repeater 130 exists between the mesh gate 110 and the end apparatus 150, the repeater 130 relays a PXU message to an upper level apparatus (S410). The mesh gate 110 having received a PXU message transmits a proxy update confirmation (PXUC) message to the end apparatuses 120 and 150 (S420). Even in this case, when the repeater 130 exists on a path that connects the mesh gate 110 and the end apparatus 150, the repeater 130 forwards a PXUC message (S430).

The mesh gate 110 may monitor a state change of all apparatuses that are maintained in a lower part of a specific M-STA in real time with the above-described method, and thus may manage information about a station that is maintained in real time.

As the M2M service application technique in an MBSS according to the present invention uses a routing protocol such as an AODV or DYMO, the M2M service application technique can be applied even to a layer 3. However, because a RANN message and a GANN message do not exist in the layer 3, the routing technique of the present invention can be applied to a procedure that is described in FIG. 3.

According to an exemplary embodiment of the present invention, information about an M2M service terminal that is connected to an MBSS is collected by an end apparatus of the MBSS, and is then transmitted to a mesh gate via a repeater in a form of a PXU message or a PXUC message, and thus a state of general stations that are positioned at a lower part of an AP can be reflected in real time to MBSS operation and be forwarded to an M2M service server of an external network through a DS.

According to an exemplary embodiment of the present invention, first setting path information of a wireless mesh network can be updated with changed path information that changes in real time. Further, when information of apparatuses that are connected to all mesh gates is considered, path information that can be changed in real time can be searched for, it can be thus detected that an abnormal situation occurs in a specific apparatus of a wireless mesh network, a type of an abnormal situation of an apparatus can be searched for, and a direction in which an abnormal situation is propagated can be searched.

According to another exemplary embodiment of the present invention, after information about an M2M service terminal is received by an end mesh station apparatus of a wireless mesh network, as the information is transmitted to a mesh gate through a proxy update message, a state of each M2M service terminal can be reflected in real time in wireless mesh network operation, and the information can be transmitted to an M2M service server of an external network through a distribution system. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of routing in a mesh gate of a wireless mesh network (MBSS), the method comprising:
transmitting a gate announcement (GANN) message to a plurality of mesh stations (M-STAB) of the MBSS;
receiving a first path request (PREQ) message from a first M-STA of the plurality of M-STAB;
transmitting a first path reply (PREP) message to the first M-STA in response to the first PREQ message; and
storing path information from the mesh gate to the first M-STA based on the first PREQ message.

2. The method of claim 1, wherein the transmitting of the GANN message comprises transmitting the GANN message to the first M-STA by unicast when storing information about the first M-STA.

3. The method of claim 2, wherein the information comprises a media access control address of the first M-STA.

4. The method of claim 1, wherein the first PREP message comprises the stored path information.

5. The method of claim 1, further comprising:
transmitting a second PREQ message to a second M-STA, when path information to the second M-STA of the plurality of M-STAB is not stored;
receiving a second PREP message from the second M-STA in response to the second PREQ message; and
storing path information from the mesh gate to the second M-STA based on the second PREP message.

6. The method of claim 1, wherein the first PREQ message is received to the mesh gate via a repeater, the first PREP message is forwarded to the first M-STA via the repeater, and at least one of the first PREQ message and the first PREP message comprises information of the repeater, when the repeater exists on a path from the mesh gate to the first M-STA.

7. The method of claim 6, wherein the information of the repeater comprises a media access control address of the repeater.

8. The method of claim 1, wherein the GANN message is periodically transmitted according to a first transmission interval.

9. The method of claim 8, wherein the GANN message comprises information about the first transmission interval.

10. The method of claim 8, further comprising storing the path information and then periodically receiving a second PREQ message from the first M-STA according to a second transmission interval when the first M-STA is positioned at an end portion of the MBSS.

11. The method of claim 10, wherein the second transmission interval is the same as the first transmission interval.

12. The method of claim 10, further comprising:
receiving a path error message from a repeater when the repeater exists on a path from the mesh gate to the first M-STA; and
updating path information based on the path error message,
wherein the path error message is generated when the second PREQ message is not periodically received from the first M-STA.

13. The method of claim 12, further comprising updating the updated path information based on the path error information based on the received second PREQ message when the mesh gate again receives the second PREQ message from the first M-STA via the repeater.

14. A method of extending a routing protocol at a mesh access point (AP) that performs a function of an AP of a plurality of M-STAB of an MBSS, the method comprising:
receiving information of a general station from the general station that is positioned at a lower level of the mesh AP;
transmitting a proxy update (PXU) message comprising information of the general station to a mesh gate of the MBSS; and
receiving a proxy update confirmation (PXUC) determination message from the mesh gate in response to the PXU message.

15. The method of claim 14, wherein the information of the general station comprises a media access control address of the general station.

16. A method of extending a routing protocol at a mesh access point (AP) that performs a function of an sensor gateway of a plurality of M-STAB of an MBSS, the method comprising:
receiving information of a sensor from the sensor that is positioned at a lower level of the mesh AP;
transmitting a proxy update (PXU) message comprising information of the sensor to a mesh gate of the MBSS; and
receiving a proxy update confirmation (PXUC) determination message from the mesh gate in response to the PXU message.

17. The method of claim 16, wherein the sensor comprises an M2M service terminal.
